(19) United States
(12) Patent Application Publication
(10) Pub. No.: US 2025/0091539 A1
(43) Pub. Date: Mar. 20, 2025

(54) BOTTOM STRUCTURE OF VEHICLE

(71) Applicant: Honda Motor Co., Ltd., Tokyo (JP)

(72) Inventors: Yoshikatsu OTA, Saitama (JP); Ken KATSURAI, Tokyo (JP); Yoshiro ISHINABE, Tokyo (JP); Shigeru IBA, Tokyo (JP); Yasuhiko KAWASE, Tokyo (JP); Keita ISHIHARA, Saitama (JP); Naoki TANI, Tokyo (JP)

(73) Assignee: Honda Motor Co., Ltd., Tokyo (JP)

(21) Appl. No.: 18/830,595

(22) Filed: Sep. 11, 2024

(30) Foreign Application Priority Data
Sep. 14, 2023 (CN) 202311186549.X

(51) Int. Cl. B60R 16/04; B62D 25/02; B62D 25/20

(52) U.S. Cl. CPC B60R 16/04; B62D 25/025; B62D 25/2036

(57) ABSTRACT

A bottom structure of vehicle includes a side sill disposed at outside in a width direction of vehicle and extending in a front/rear direction of vehicle; a power unit housing disposed between the side sills and including a battery component inside; and a frame connecting the side sill and the power unit housing. An upper surface of the frame and an upper surface of the power unit housing are formed as a floor member.

### CROSS-REFERENCE TO RELATED APPLICATION

This application claims the priority benefit of China application serial no. 202311186549.X, filed on Sep. 14, 2023. The entirety of the above-mentioned patent application is hereby incorporated by reference herein and made a part of this specification.

### BACKGROUND

### Technical Field

This disclosure relates to a bottom structure of vehicle.

### Description of Related Art

In order to provide a sustainable transportation system for disadvantaged groups such as the elderly, the physically challenged, and children, it is committed to providing transportation with superior vehicle comfort. In the existing technology, the floor surface of the bottom structure of vehicle includes structures such as a floor channel and a curved structure such as an incline at the end in the width direction of vehicle. As a result, it is difficult to form a lower height floor surface in the existing vehicle body, and it is difficult to have a wider space for the feet of the passengers to be placed, which reduces the comfort of the ride. The disclosure aims to solve the above-mentioned problem by improving the rideability of a vehicle and providing a sustainable transportation system.

### SUMMARY

A bottom structure of vehicle of the disclosure includes a side sill disposed at outside in a width direction of vehicle and extending in a front/rear direction of vehicle; a power unit housing disposed between the side sills and including a battery component inside; and a frame connecting the side sill and the power unit housing. An upper surface of the frame and an upper surface of the power unit housing are formed as a floor member.

### BRIEF DESCRIPTION OF THE DRAWINGS

FIG. 1 is a schematic top view of a bottom structure of vehicle according to an embodiment of the disclosure.

FIG. 2 is a schematic cross-sectional view of the bottom structure of vehicle of FIG. 1 along a section line A-A.

FIG. 3 is a partial bottom view of a bottom structure of vehicle according to the disclosure.

FIG. 4 is a schematic cross-sectional view of the bottom structure of vehicle of FIG. 1 along a section line B-B.

### DESCRIPTION OF THE EMBODIMENTS

The disclosure provides a bottom structure of vehicle, capable of suppressing the height of a vehicle body to ensure the comfort of the inner space.

In an embodiment of the disclosure, the frame is fixed to a lower surface of the side sill at the outside in the width direction of vehicle, and the upper surface of the power unit housing is formed higher than the upper surface of the frame in an up/down direction of vehicle.

In an embodiment of the disclosure, the frame is joined to a flange portion of the power unit housing, and the flange portion extends from inside of the power unit housing toward the outside in the width direction of vehicle.

In an embodiment of the disclosure, the frame includes an upper frame and a lower frame, and the upper frame and the lower frame are joined to form a closed cross-section. An inner end portion of the lower frame in the width direction of vehicle is joined to the upper frame at a position away from the power unit housing.

In an embodiment of the disclosure, the bottom structure of vehicle further includes a lower support member. The lower support member is connected to a lower surface of the closed cross-section of the frame and a lower surface of the power unit housing.

In an embodiment of the disclosure, the upper surface of the power unit housing is joined to a floor beam extending in the width direction of vehicle, and an end portion of the floor beam in the width direction of vehicle is joined to an upper surface of the side sill.

In an embodiment of the disclosure, the side sill is joined to the floor beam through a connecting member. The connecting member protrudes inward in the width direction of vehicle from the upper surface of the side sill.

In an embodiment of the disclosure, the floor beam is joined to the closed cross-section of the frame.

In an embodiment of the disclosure, a bottom of the side sill in an up/down direction of vehicle includes a sealing surface and a fixing surface. The sealing surface is located inside relative to the fixing surface in the width direction of vehicle, and at the upper in the up/down direction of vehicle.

In an embodiment of the disclosure, the frame is disposed at an outer end portion in the width direction of vehicle, and the power unit housing is disposed at a center portion in the width direction of vehicle. The power unit housing further includes a first storage portion and a second storage portion. The second storage portion is disposed further rearward than the first storage portion in the front/rear direction of vehicle, and an upper surface of the second storage portion is formed to be higher than an upper surface of the first storage portion in an up/down direction of vehicle. The floor beam is fixed along a front end of the second storage portion.

Based on the above, in the bottom structure of vehicle of the disclosure, the upper surfaces of the frame and the power unit housing are formed as a floor surface, so that the height in the up/down direction of vehicle may be suppressed to ensure inner space. At the same time, the frame and the power unit housing are components that are separate from the vehicle body skeleton (side sills and the like) and may be freely assembled to improve productivity. In addition, when a side impact occurs, the load may be absorbed by the frame first to suppress the deformation of the power unit housing. Accordingly, the bottom structure of vehicle of the disclosure may suppress the height of the vehicle body to ensure the comfort of the inner space.

To make the aforementioned more comprehensible, several embodiments accompanied with drawings are described in detail as follows.

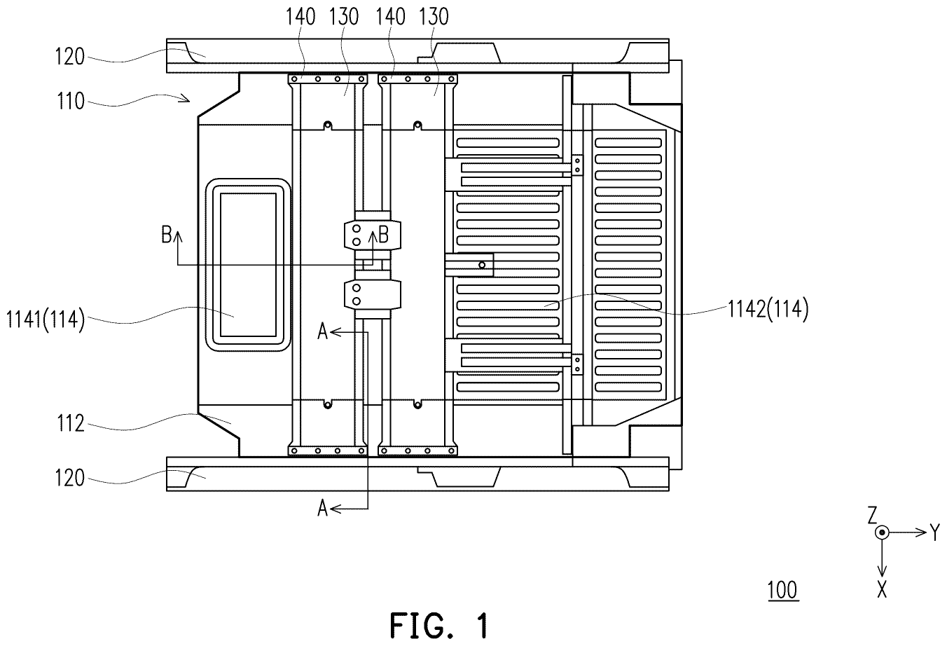

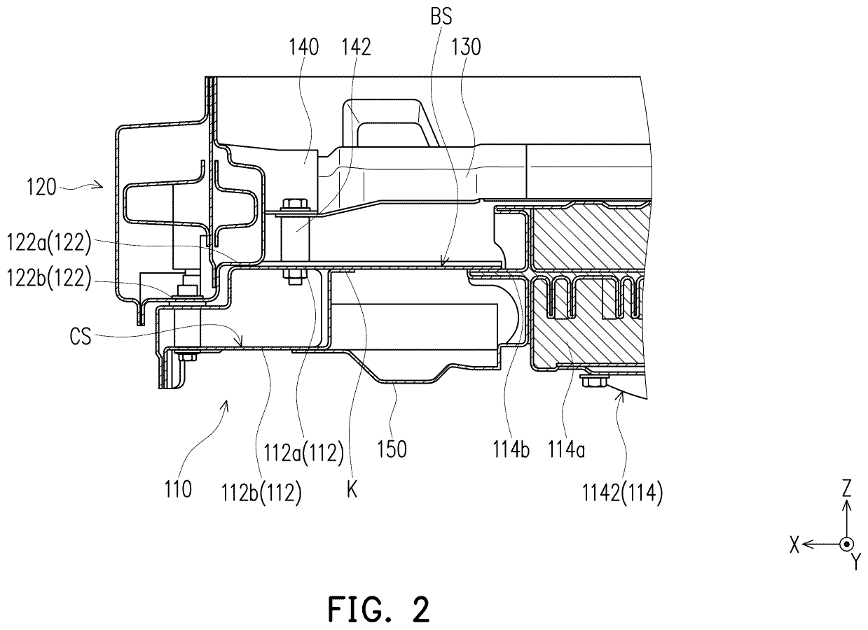

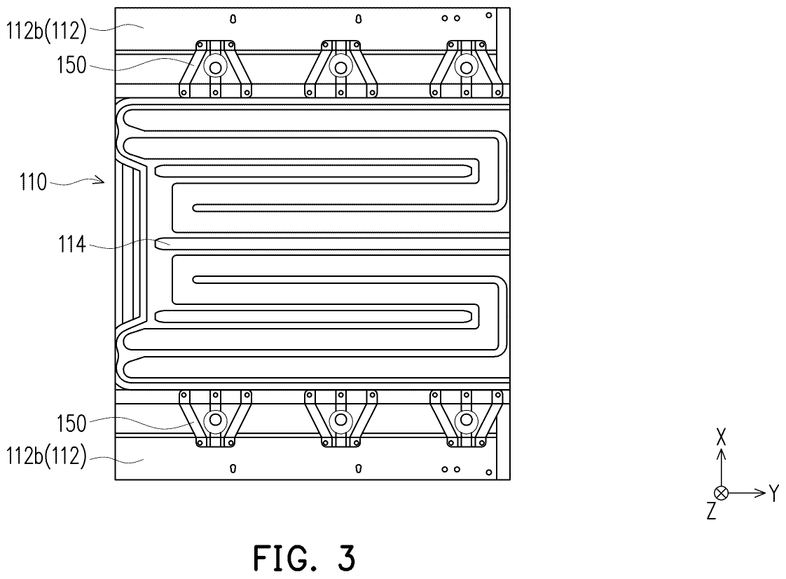

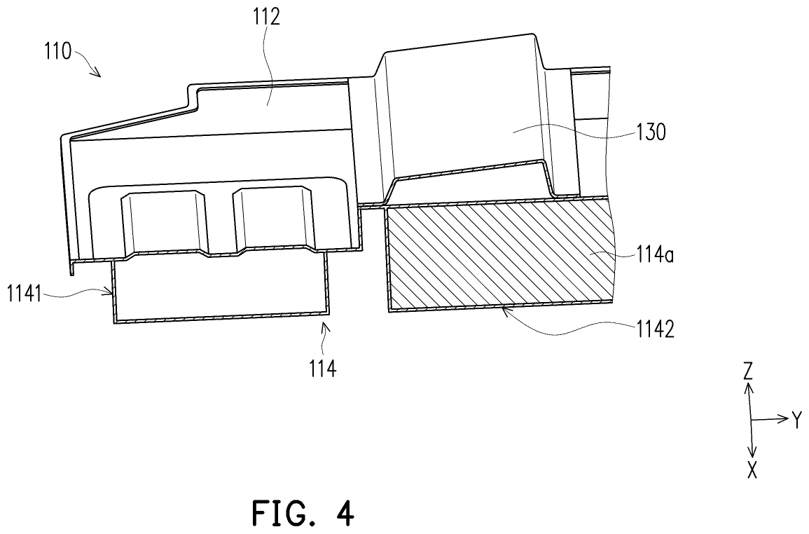

FIG. 1 is a schematic top view of a bottom structure of vehicle according to an embodiment of the disclosure. FIG. 2 is a schematic cross-sectional view of the bottom structure of vehicle of FIG. 1 along a section line A-A. FIG. 3 is a partial bottom view of a bottom structure of vehicle according to the disclosure. FIG. 4 is a schematic cross-sectional view of the bottom structure of vehicle of FIG. 1 along a section line B-B. In this embodiment, a bottom structure of vehicle 100 is, for example, a bottom structure used in ordinary passenger cars (not shown), but the disclosure is not limited thereto and may also be applied to other types of vehicles. A width direction X, a front/rear direction Y, and a up/down direction Z of vehicle in the drawings are not intended to limit the positional relationship of each component in the disclosure. In addition, it should be noted that in the following descriptions, unless otherwise specified, the rear and top are the directions indicated by the arrows in the front/rear direction Y and the up/down direction Z of vehicle; the front and bottom are the opposite directions of the previous ones; inside and outside are in terms of relative positions in the width direction X of vehicle, and the direction indicated by the arrows in the width direction X of vehicle is not intended to limit the inside or outside. Whenever possible, the same reference numerals are used in the drawings and description to refer to the same or similar parts. The bottom structure of vehicle 100 of this embodiment is described below with reference to FIG. 1 to FIG. 4.

Please refer to FIG. 1. In this embodiment, the bottom structure of vehicle 100 includes a floor member 110, side sills 120, and floor beams 130. The floor member 110 is formed by an upper surface of a frame 112 and an upper surface of a power unit housing 114. The frame 112 is disposed at an outer end portion in a width direction X of vehicle, the power unit housing 114 is disposed at a center portion in the width direction X of vehicle, and the power unit housing 114 is formed as a substantially flat surface, and the disclosure is not limited thereto. The side sills 120 are disposed outside the floor member 110 in the width direction X of vehicle and extends in a front/rear direction Y of vehicle, the power unit housing 114 is disposed between the side sills 120, and the frame 112 connects the side sills 120 and the power unit housing 114. That is, the side sill 120, the frame 112, and the power unit housing 114 are disposed in order from the outside to the inside in the width direction X of vehicle. The interior of the power unit housing 114 includes a battery component 114a. The floor beam 130 is disposed above the floor member 110 in a up/down direction Z of vehicle and extends in the width direction X of vehicle, and end portions thereof are connected to the side sills 120.

It can be seen that in the bottom structure of vehicle 100 of this embodiment, the upper surfaces of the frame 112 and the power unit housing 114 are formed as a floor surface, so that the height in the up/down direction Z of vehicle may be suppressed to ensure inner space. At the same time, the frame 112 and the power unit housing 114 are components that are separate from the vehicle body skeleton (side sills 120 and the like) and may be freely assembled to improve productivity. In addition, when a side impact occurs, the load may be absorbed by the frame 112 first to suppress the deformation of the power unit housing 114. Accordingly, the bottom structure of vehicle 100 of this embodiment may suppress the height of the vehicle body to ensure the comfort of the inner space.

Furthermore, please refer to FIG. 2. In this embodiment, the power unit housing 114 is, for example, a housing of an intelligent power unit (IPU) to protect the intelligent power unit located therein. Moreover, the power unit housing 114 is assembled below the vehicle body skeleton (partially shown). The vehicle body skeleton is formed, for example, by the side sills 120, a front wall panel (not shown, for example, made of high-strength materials such as heat-treated materials), and a rear member (not shown). For example, the power unit housing 114 is installed on the floor beam 130, and then the frame 112 is installed on the side sill 120, and the vehicle body skeleton and the power unit housing 114 are sealed to prevent water intrusion. In addition, the power unit housing 114 is connected to the vehicle body skeleton by, for example, screws or bolts, but the disclosure is not limited thereto.

In addition, in this embodiment, the upper surface of the power unit housing 114 is formed higher than an upper surface of the frame 112 in the up/down direction Z of vehicle. That is, there is a step difference between the frame 112 and the power unit housing 114. In this way, the step difference formed between the frame 112 and the power unit housing 114 may ensure that the space of the power unit housing 114 is sufficient to accommodate the battery component 114a.

Furthermore, the floor beam 130 and the frame 112 of the floor member 110 are spaced apart from each other in the up/down direction Z of vehicle to form a crush space BS, and the upper surface of the power unit housing 114 is joined to the floor beam 130. The frame 112 is fixed to a lower surface of the side sill 120 at the outside in the width direction X of vehicle, and the end portion of the floor beam 130 in the width direction X of vehicle is joined to an upper surface of the side sill 120. In other words, the frame 112 is fixed to the floor beam 130 by clamping the side sill 120 up and down in the up/down direction Z of vehicle. As a result, it is possible to actually transfer the load to the outer end portion 112 and the floor beam 130 in the event of a side impact, thereby ensuring that a deformation is generated in the crush space BS to absorb the impact.

Furthermore, in this embodiment, the frame 112 is joined to a flange portion 114b of the power unit housing 114. The flange portion 114b extends from the inner side of the power unit housing 114 toward the outer side in the width direction X of vehicle, and is joined to the frame 112 by screws or bolts, but the disclosure is not limited thereto. In this way, it may be ensured that the load of a side impact is transmitted to the power unit housing 114 through the frame 112, thereby improving the rigidity. Moreover, the upper surface connected to the frame 112 makes it easier for the floor member 110 to deform to absorb impacts, thereby preventing the crush space BS from being ineffective due to excessive rigidity. At the same time, after the frame 112 is connected to the power unit housing 114, the number of parts may be reduced compared with the prior art to further ensure the inner space.

Next, in this embodiment, the frame 112 includes an upper frame 112a and a lower frame 112b. The upper frame 112a and the lower frame 112b are joined to form a closed cross-section CS, and an inner end portion K of the lower frame 112b in the width direction X of vehicle is joined to the upper frame 112 at a position away from the power unit housing 114. By joining at a position far away from the power unit housing 114, the increase in rigidity in the crush space BS may be reduced, and a certain rigidity difference with the side sills 120 may be created to more easily deform the crush space BS. In addition, the inner end portion K of the lower frame 112b away from the power unit housing 114 allows for a higher support rigidity of the upper frame 112a.

Furthermore, in the embodiment, the side sill 120 is joined to the floor beam 130 through a connecting member 140. In detail, the connecting member 140 protrudes inward in the width direction X of vehicle from the upper surface of the side sill 120, and is fixed to the floor beam 130 through a fixing member 142. The fixing member 142 is, for example, a combination of screws and bolts, but the disclosure is not limited thereto. Furthermore, the floor beam 130 is connected to the closed cross-section CS of the frame 112 through the fixing member 142, that is, the fixing member 142 passes through the floor beam 130 and the closed cross-section CS to fix the floor beam 130. Such a configuration may ensure better joint strength and support rigidity when the power unit housing 114 (the floor member 110) is joined to the vehicle body skeleton (the side sill 120, etc.). In particular, the way in which the floor beam 130 overlaps with the side sill 120 in the width direction of vehicle X of vehicle allows the load in a side impact to be transferred from the side sill 120 to the floor beam 130 to spread out the load, and thus increase rigidity.

Furthermore, in this embodiment, a bottom 122 of the side sill 120 in the up/down direction Z of vehicle includes a sealing surface 122a and a fixing surface 122b. The sealing surface 122a is used to seal a gap between the side sill and the frame 112, while the fixing surface 122b is fixed to the frame 112 through a fastening member. Specifically, the sealing surface 122a is located inside relative to the fixing surface 122b in the width direction X of vehicle, and at the upper in the up/down direction Z of vehicle. In this way, it is more difficult for water from the outside of the vehicle to enter the inside from low to high, and the sealing surface 122a is disposed separately from the fixing surface 122b to improve precision in assembly.

Please refer to FIG. 2 and FIG. 3. In this embodiment, the bottom structure of vehicle 100 further includes a lower support member 150. The lower support member 150 is connected to a lower surface of the closed cross-section CS of the frame 112 and a lower surface of the power unit housing 114 to further ensure the joint strength of the frame 112 and the power unit housing 114, so that the frame 112 achieves an effect of supporting the power unit housing 114. In addition, due to the need for wiring (not shown) of the vehicle body, it is not possible to have the wiring configured in a completely closed cross-section and thus disposed above the lower support member 150, but the disclosure is not limited thereto.

Please refer to FIG. 1 and FIG. 4. In this embodiment, the power unit housing 114 further includes a first storage portion 1141 and a second storage portion 1142. The second storage portion 1142 is disposed further rearward than the first storage portion 1141 in the front/rear direction Y of vehicle, and an upper surface of the second storage portion 1142 is formed to be higher than an upper surface of the first storage portion 1141 in the up/down direction Z of vehicle. Thus, the second storage portion 1142 with a larger storage space may be used to place the battery component 114a, but the disclosure is not limited thereto, the battery component 114a may also be disposed in the first storage portion 1141. In addition, the floor beam 130 is fixed along a front end of the second storage portion 1142, that is, a front end of the floor beam 130 overlaps the front end of the second storage portion 1142 in the up/down direction Z of vehicle. In this way, when an impact occurs, the load input from the floor beam 130 may be borne by the front end of the second storage portion 1142, thereby improving the overall rigidity. In addition, since the floor member 110 is equipped with a seat (not shown), the first storage portion 1141 with a lower height in the up/down direction Z of vehicle may provide a more comfortable space for the feet of the passengers to improve riding comfort.

In summary, in the bottom structure of vehicle of the disclosure, the upper surfaces of the frame and the power unit housing are formed as a floor surface, so that the height in the up/down direction of vehicle may be suppressed to ensure inner space. At the same time, the frame and the power unit housing are components that are separate from the vehicle body skeleton (side sills and the like) and may be freely assembled to improve productivity. In addition, when a side impact occurs, the load may be absorbed by the frame first to suppress the deformation of the power unit housing. Furthermore, the power unit housing further includes a first storage portion with a lower height in the up/down direction of vehicle and a second storage portion with a higher height in the up/down direction of vehicle. In this way, a more comfortable space may be provided for passengers and space for placing the battery component may be ensured. Accordingly, the bottom structure of vehicle of the disclosure may suppress the height of the vehicle body to ensure the comfort of the inner space.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A bottom structure of vehicle, comprising:
a side sill, disposed at outside in a width direction of vehicle and extending in a front/rear direction of vehicle;
a power unit housing, disposed between the side sills and comprising a battery component inside; and
a frame, connecting the side sill and the power unit housing, wherein an upper surface of the frame and an upper surface of the power unit housing are formed as a floor member.

2. The bottom structure of vehicle according to claim 1, wherein
the frame is fixed to a lower surface of the side sill at the outside in the width direction of vehicle, and
the upper surface of the power unit housing is formed higher than the upper surface of the frame in an up/down direction of vehicle.

3. The bottom structure of vehicle according to claim 2, wherein
the frame is joined to a flange portion of the power unit housing, and the flange portion extends from inside of the power unit housing toward the outside in the width direction of vehicle.

4. The bottom structure of vehicle according to claim 1, wherein
the frame comprises an upper frame and a lower frame, and the upper frame and the lower frame are joined to form a closed cross-section, and
an inner end portion of the lower frame in the width direction of vehicle is joined to the upper frame at a position away from the power unit housing.

5. The bottom structure of vehicle according to claim 4, further comprising a lower support member, wherein the lower support member is connected to a lower surface of the closed cross-section of the frame and a lower surface of the power unit housing.

6. The bottom structure of vehicle according to claim 4, wherein
the upper surface of the power unit housing is joined to a floor beam extending in the width direction of vehicle, and
an end portion of the floor beam in the width direction of vehicle is joined to an upper surface of the side sill.

7. The bottom structure of vehicle according to claim 6, wherein
the side sill is joined to the floor beam through a connecting member, the connecting member protrudes inward in the width direction of vehicle from the upper surface of the side sill.

8. The bottom structure of vehicle according to claim 6, wherein
the floor beam is joined to the closed cross-section of the frame.

9. The bottom structure of vehicle according to claim 1, wherein
a bottom of the side sill in an up/down direction of vehicle comprises a sealing surface and a fixing surface,
the sealing surface is located inside relative to the fixing surface in the width direction of vehicle, and at the upper in the up/down direction of vehicle.

10. The bottom structure of vehicle according to claim 1, wherein
the frame is disposed at an outer end portion in the width direction of vehicle, the power unit housing is disposed at a center portion in the width direction of vehicle,
the power unit housing further comprises a first storage portion and a second storage portion, the second storage portion is disposed further rearward than the first storage portion in the front/rear direction of vehicle, and an upper surface of the second storage portion is formed to be higher than an upper surface of the first storage portion in an up/down direction of vehicle, and
the floor beam is fixed along a front end of the second storage portion.
